(19) United States
(12) Patent Application Publication
(10) Pub. No.: US 2008/0002760 A1
(43) Pub. Date: Jan. 3, 2008

(54) Method and apparatus for automatic distribution of device drivers

(76) Inventors: John Wallace Nasielski, San Diego, CA (US); James L. Panian, San Marcos, CA (US); Nikolai K. N. Leung, Takoma Park, MD (US)

Correspondence Address: QUALCOMM INCORPORATED, 5775 MOREHOUSE DR., SAN DIEGO, CA, 92121, US

(21) Appl. No.: 11/478,259

(22) Filed: Jun. 28, 2006

(51) Int. Cl. H04L 5/16

(52) U.S. Cl. 375/222

(57) ABSTRACT

Method and apparatus for automatic distribution of device drivers. The method provides for a combination removable memory card and modem. Device drivers are stored in a memory portion of a PCMCIA card. Upon insertion into an access device the drivers may be automatically loaded onto the access device, permitting users to immediately utilize the device without having to load device drivers from a separate CD-ROM. Embodiments allow for a PCMCIA card with a switch that may be set to the “install” position on first insertion of the card into an access device. The user removes the card and re-installs the PCMICA card, which now acts as a modem. Additional embodiments allow for an automated process, with device drivers loaded automatically using an auto-execution script or an executable file.

### BACKGROUND

1. Field

The present invention pertains generally to installing device drivers, and more specifically, to a method and apparatus for automatic distribution of device drivers.

2. Background

A device driver is a program that controls a particular type of device that is attached to a computer. A device driver typically converts the more general input/output instructions of the operating system to messages that a particular device can understand. Many users will be familiar with the use of device drivers to direct printing using an associated printer. There are device drivers for printers, displays, CD-ROM readers, diskette drives, etc. An Operating System (OS) is software resident within a computer which controls basic functions. Examples of operating systems include Microsoft Windows, Linux, and DOS. Most OSs include device drivers incorporated into the product. However, if a user wants to support a new type of device that was not anticipated by the OS, the user must install a new device driver for that device.

Virtual device drivers may be provided for each main hardware device in the system, including the hard disk drive controller, keyboard, serial and parallel ports. These virtual device drivers maintain the status of a hardware device that has variable settings. Virtual device drivers handle software interrupts from the system rather than hardware interrupts. Some Microsoft Windows programs are virtual device drivers that interface with the Windows Virtual Machine Manager. In Windows operating systems, a device driver file usually has a file name suffix of DLL or EXE. A virtual device driver usually has the suffix VXD. Other operating systems may use different conventions to denominate similar features.

The Personal Computer Memory Card International Association (PCMCIA) specifies the technical standards for small cards which are able to plug into laptop computers to provide enhanced functions. A PC card, also known as a PCMCIA card is a credit card-sized memory or input/output (I/O) device that fits into the card slot in a personal computer, such as that found on a notebook or laptop computer. PC cards are commonly used to provide telecommunication modems for notebook computers. Common examples of these cards include: network cards, modem cards, and security cards. Most PC cards are designed to comply with standards published by the Personal Computer Memory Card International Association (PCMCIA), an industry group that promotes standards for both memory and I/O integrated circuit cards. The PCMCIA standard if most commonly applied to portable personal computers, but may also be used with desktop computers. Distribution of device drivers for current wireless modems is a problem, particularly those in PCMCIA compliant cards. Other device drivers and personal computer card formats may also be affected by the problem.

Plug-in applications are programs that can easily be installed and used as part of a Web browser. Initially, helper applications used with the Netscape browser (a Microsoft application) allowed a user to download, install, and define supplementary programs that played sound or motion videos, or performed other functions. Helper applications run as separate applications and require the opening of a second window. In contrast, the browser automatically recognizes plug-in applications and their function is integrated into the main HTML file being presented. Popular plug-ins to download include Adobe Acrobat, a document presentation and navigation program that allows users to view documents as they would appear in print medium, RealNetworks' streaming video player, and Macromedia's Shockwave for Director, an interactive animation and sound player. Most users install a particular plug-in when the need arises.

Plug and Play (PnP) capability was originally developed by Microsoft for its OS that uses the ability to plug a device into a computer and have the computer recognize that the device is present. An open industry standard, known as Universal Plug and Play (UPnP) uses Internet protocols for seamless device plug in. With PnP, the user does not need to explicitly tell the computer's OS when a new device has been added. Thus, in a Microsoft Windows OS environment, devices may be supported “plug and play”, such that the Windows OS has native device drivers available and can recognize and configure new hardware. Other OSs may also provide “plug and play” capability.

“Plug and play capability” allows a user to connect a new device and use the native device drivers found in the OS. A problem may arise if the OS does not provide native device drivers for the new hardware. If the OS is not able to recognize the device, then it will prompt users for the location of the driver software. Driver software may be distributed on a CD-ROM, or downloaded from the Internet. This can be undesirable since the CD-ROM can easily be separated from the device and users may not have Internet access at the moment of hardware installation. In either case, the software will not be available. In addition, even if the CD-ROM is available, the installation of the card still requires some level of user interaction, as does accessing the Internet for the drivers. This may make it difficult to lend a card to another computer. The same problem also exists with wireless modems which may be in the PCMCIA or other PC card format.

Wireless modems may also be located on PCMCIA cards. CDMA devices will continue to be at a disadvantage without an automatic method for installing device drivers. There is therefore, a need in the art for techniques and apparatus that allow for automatic distribution of device drivers.

### SUMMARY

A method for automatic distribution of device drivers is provided by the present invention. The method is comprised of the following steps: setting a modem card to a particular setting, based on a desired operational mode; inserting the modem card into a device; and operating the modem card in accordance with the particular setting.

An apparatus for automatic distribution of device drivers is provided by the present invention. The apparatus is comprised of: means for setting a modem card to a particular setting, based on a desired operational mode; means for inserting the modem card into a device; and means for operating the modem card in accordance with the particular setting.

A computer-readable medium including computer executable instructions for automatic distribution of device drivers is provided by the present invention. The computer-readable medium is comprised of the following: setting a modem card to a particular setting, based on a desired operational mode; inserting the modem card into a device; and operating the modem card in accordance with the particular setting.

### BRIEF DESCRIPTION OF THE DRAWINGS

The features, objects, and advantages of the presently disclosed method and apparatus will become more apparent from the detailed description set forth below when taken in conjunction with the drawings in which like reference characters identify correspondingly throughout and wherein:

FIG. 1 depicts a laptop computer with Internet connectivity.

FIG. 2 illustrates a PCMCIA card according to an embodiment.

FIG. 3 is a diagram for an embodiment of a method for automatic installation of device drivers.

FIG. 4 is a diagram for an embodiment of a method for automatic installation of device drivers using a PCMCIA card.

FIG. 5 is a diagram for an embodiment of a method for automatic installation of device drivers using a PCMCIA card that is recognized as memory and as a modem.

FIG. 6 is a diagram for an embodiment of a method for automatic installation of device drivers using a PCMCIA card that connects a modem to the Internet for downloading current device drivers.

FIG. 7 is a diagram for an embodiment of a method for automatic installation of device drivers using a PCMCIA card that appears as a memory card containing an executable file.

FIG. 8 is a block diagram of an apparatus for automatic installation of device drivers.

### DETAILED DESCRIPTION OF THE INVENTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration”. Any embodiment described herein as “exemplary” is not necessarily to be construed as preferred or advantageous over other embodiments. Likewise, the term “embodiments of the invention” does not require that all embodiments of the invention include the discussed feature, advantage, or mode of operation.

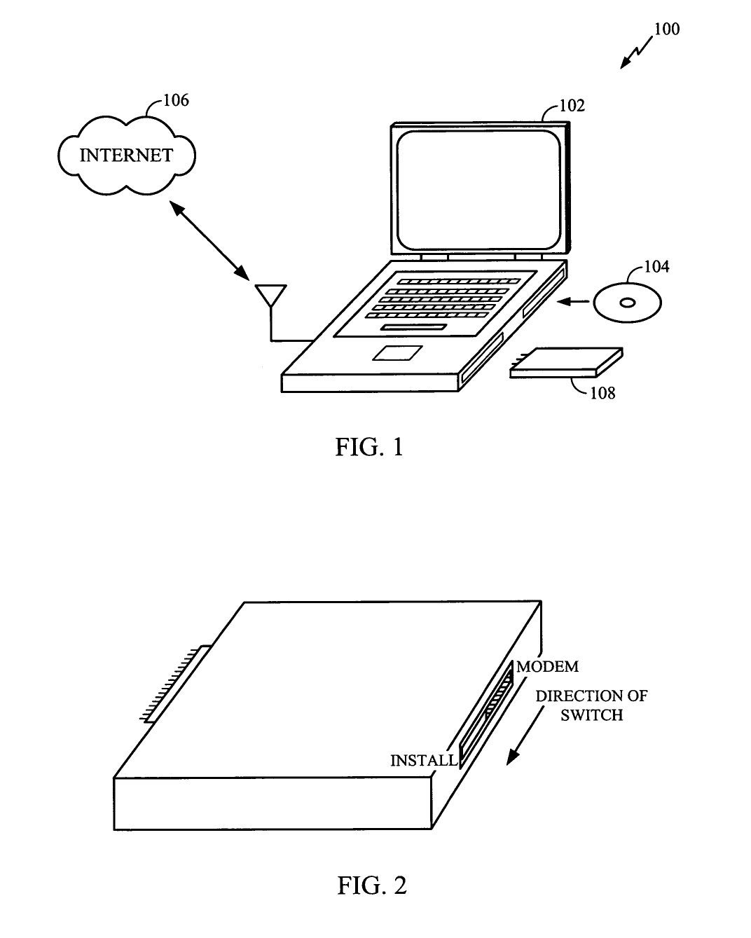

FIG. 1 shows a laptop computer system 100 commonly used with PCMCIA cards. The laptop computer 102 may have a CD-ROM drive that accepts CD-ROM discs, 104. The laptop may also have slots for installing one or more PCMCIA cards, 108. In this application the PCMCIA card may include a wireless modem as well as memory. The laptop may connect to the Internet, 106 via a wired or wireless connection. Other devices such a portable digital assistants (PDA) and mobile phones may also have Internet access capability and support the use of PCMCIA cards. These devices may be known as Access Devices (AD) for their ability to access wireless communication systems as well as the Internet. This description uses the term AD to refer to any of the above mentioned devices.

When a user installs a new hardware device, such as a PCMCIA card, the OS first looks for a native device driver with which to operate the device. If a native device driver is not found, the OS will prompt the user to supply the location of the driver software. As discussed above, this is undesirable. Embodiments described herein provide for automatic installation of device drivers in ADs. This embodiment is advantageous because it does not require operating system support, separate software, or user intervention.

In one embodiment a PCMCIA card that has the necessary device drivers integrated with the device is provided. For example, a wireless modem (e.g., CDMA 1x/DO) card may reserve a small portion of memory to store the device drivers. On insertion into an AD, the card appears as a removable memory device and the memory automatically installs the device drivers.

FIG. 2 shows a PCMCIA card according to an embodiment of the invention. The card has a user controlled external configurable setting mechanism (e.g., toggle switch, push button or rotary position switch). The user sets the switch to “install” position the first time the card is inserted into the AD. The switch determines whether the card appears to the AD as removable memory or as a wireless modem. When inserted for the first time, the switch should be set to the “install” position. On subsequent insertions, the switch is moved to the “modem” setting, allowing the card to function as a wireless modem.

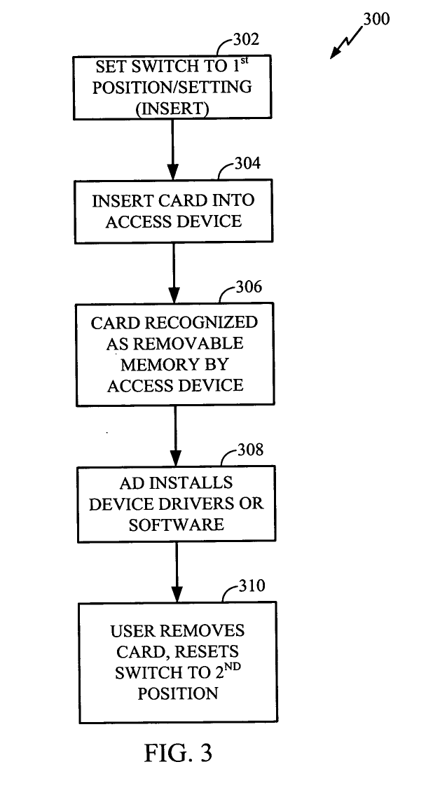

FIG. 3 details the steps of a method 300 for using a PCMCIA card having a configurable setting mechanism. In step 302, the user sets the configurable setting mechanism to the “insert” position. After setting the configurable setting mechanism, the user inserts the card in AD in step 304. Once inserted, the AD reads the card as a removable memory device in step 306. The AD installs the device drivers or other software from the card in step 308. Upon completion of the device driver installation, the user removes the card and resets the switch to the “modem” position and inserts the card in step 310.

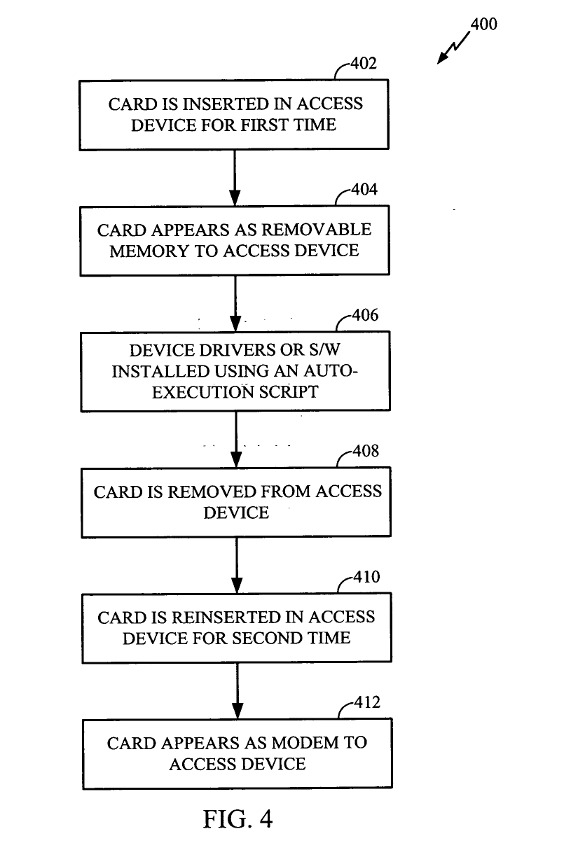

FIG. 4 is a flowchart of another embodiment of a method 400 for automatically installing device drivers or software. In step 402 the user inserts the PCMCIA card into the AD for the first time. The card appears as removable memory to the AD in step 404. The card includes an auto-execution script that automatically installs the device drivers or software in step 406. After the device drivers are installed the user removes the card from the AD in step 408. The user re-inserts the card in the AD in step 410. The card appears as a modem to the AD in step 412. The card may include software that tells the AD to see the card as a modem in step 412. One embodiment would provide for the card software/device drivers to be installed on the AD during the first insertion. This software would direct the AD to recognize the card as a modem when subsequently. An embodiment would provide for the device to check that the drivers have already been installed on the AD. Once driver installation is verified, the card would appear as a modem instead of a memory card.

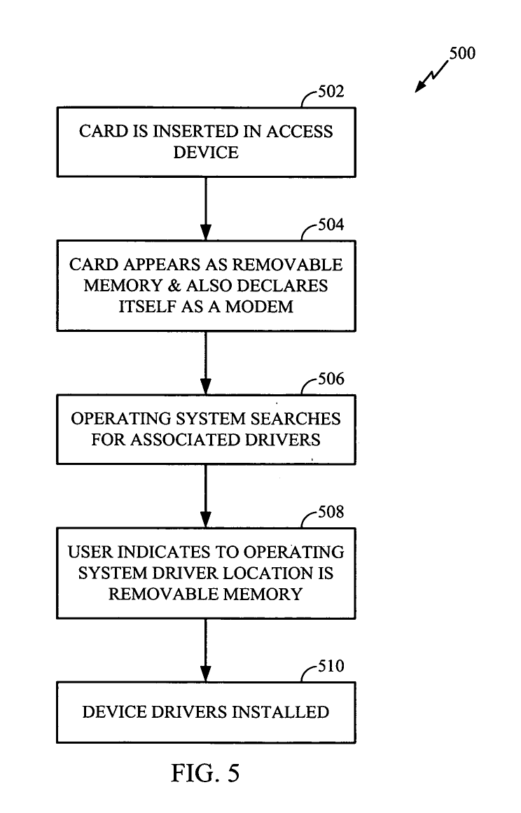

FIG. 5 is a flowchart of another embodiment of the method 500 of the invention. In step 502 the user inserts the card in the AD. The card appears as removable memory and also declares itself as a separate modem in step 504. This triggers the OS installation procedure which searches for the associated drivers. The user indicates to the OS that the driver is located in the removable memory in step 508. During step 508, the card still appears to the OS as removable memory. The device drivers are then installed in step 510.

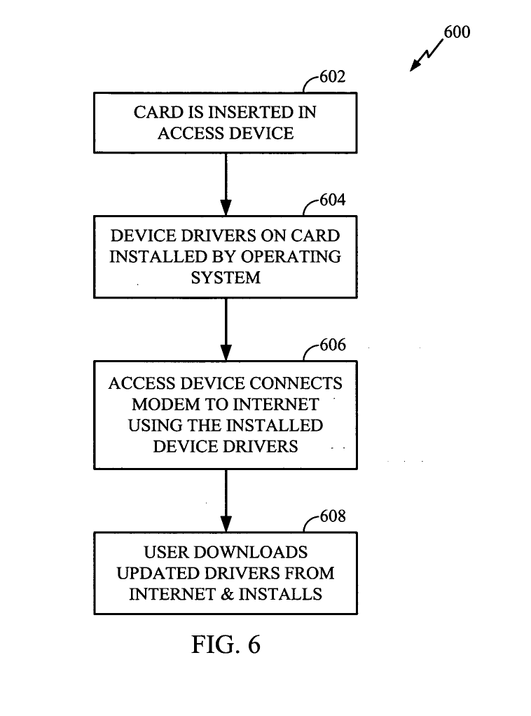

FIG. 6 is a diagram for an embodiment of a method for automatic installation of device drivers using a PCMCIA card that connects a modem to the Internet for downloading current device drivers. The method begins with step 602 with the user inserting the card in the AD. The device drivers or other software on the card are installed by the OS in step 604. The AD then uses the card as the modem to connect to the internet in step 606 and then the user downloads an updated device driver in step 608.

Yet another embodiment places an executable file on the card. The user accesses the executable file when the device appears as a memory card to the AD. The user then runs the executable file to install the device drivers. The executable file contains instructions to detect which OS it is running on; fetch the most current device driver over the internet from the device manufacturer for that OS; install the device driver ahead of the OS detecting that the device is present, thus by-passing the OS installation screens.

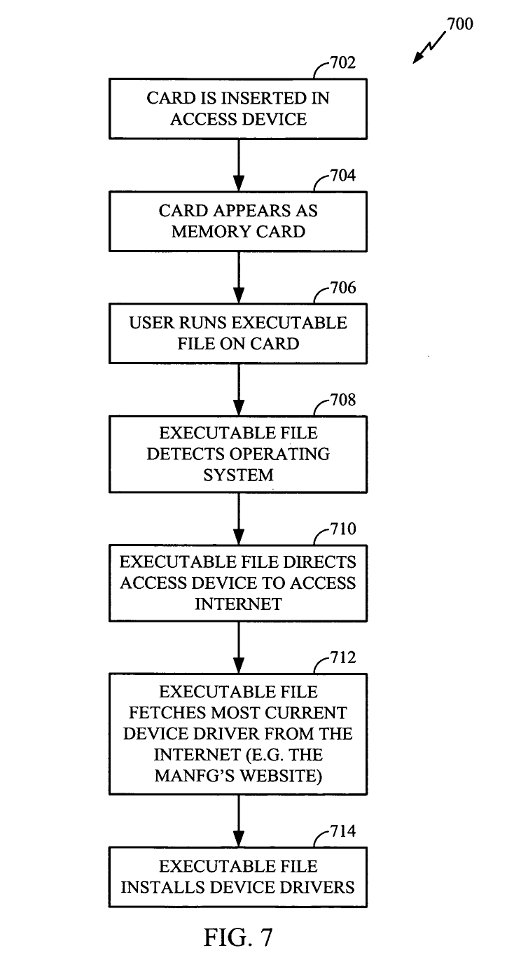

FIG. 7 is a diagram for an embodiment of a method for automatic installation of device drivers using a PCMCIA card that appears as a memory card containing an executable file. In step 702 the user inserts the card in the AD. The card appears as a removable memory card in step 704. The user runs the executable file in step 706. The executable file detects the operating system in step 708. In step 710 the executable file directs the AD to access the internet. The executable fetches the most current device driver from the manufacturer's web site in step 712. The executable file installs the device driver in step 714.

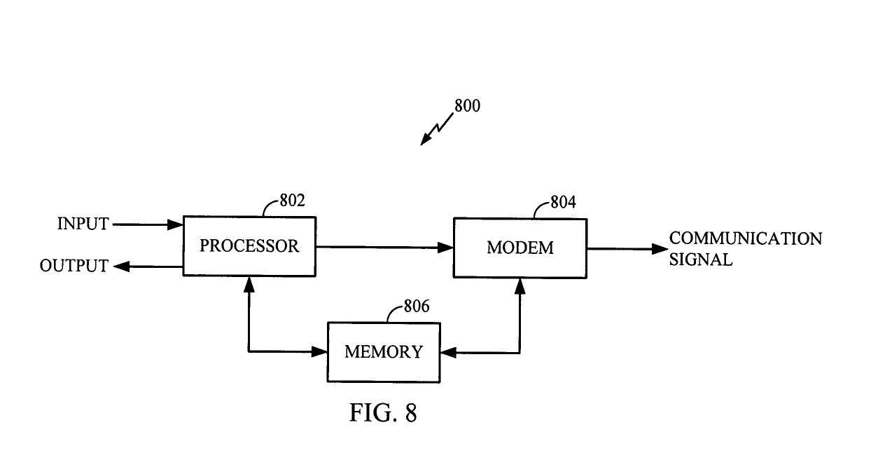

FIG. 8 is a block diagram of an apparatus for automatic installation of device drivers. The circuit 800 includes a processor 802 that communicates with a modem 804 and a memory 806. Inputs are provided to the processor 802. The processor 802 may need to retrieve the executable file from the memory 806 and will send data to the modem 804. The modem interfaces with the AD to transmit signals or data using the antenna on the AD. The processor may also output data to the AD when the PCMCIA card is being used as removable memory.

Thus, a novel and improved method and apparatus for automatic distribution of device drivers in a communications system has been described. Those of skill in the art would understand that the data, instructions, commands, information, signals, bits, symbols, and chips that may be referenced throughout the above description are advantageously represented by voltages, currents, electromagnetic waves, magnetic fields or particles, optical fields or particles, or any combination thereof. Those of skill would further appreciate that the various illustrative logical blocks, modules, circuits, and algorithm steps described in connection with the embodiments disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application. As examples, the various illustrative logical blocks, modules, circuits, and algorithm steps described in connection with the embodiments disclosed herein may be implemented or performed with a digital signal processor (DSP), an application specific integrated circuit (ASIC), a field programmable gate array (FPGA) or other programmable logic device, discrete gate or transistor logic, discrete hardware components such as, e.g., registers and FIFO, a processor executing a set of firmware instructions, any conventional programmable software module and a processor, or any combination thereof designed to perform the functions described herein. The processor may advantageously be a microprocessor, but in the alternative, the processor may be any conventional processor, controller, microcontroller, programmable logic device, array of logic elements, or state machine. The software module could reside in RAM memory, flash memory, ROM memory, EPROM memory, EEPROM memory, registers, hard disk, a removable disk, a CD-ROM, or any other form of storage medium known in the art. An exemplary processor is advantageously coupled to the storage medium so as to read information from, and write information to, the storage medium. In the alternative, the storage medium may be integral to the processor. The processor and the storage medium may reside in an ASIC. The ASIC may reside in a telephone or other user terminal. In the alternative, the processor and the storage medium may reside in a telephone or other user terminal. The processor may be implemented as a combination of a DSP and a microprocessor, or as two microprocessors in conjunction with a DSP core, etc.

In further embodiments, those skilled in the art will appreciate that the foregoing methods can be implemented by the execution of a program embodied on a computer readable medium, such are the memory of a computer platform. The instructions can reside in various types of signal-bearing or data storage primary, secondary, or tertiary media. The media may comprise, for example, RAM accessible by, or residing within, the client device and/or server. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM or EEPROM), flash memory cars, an optical storage device (e.g., CD-ROM, WORM, DVD, digital optical tape), paper “punch” cards, or other suitable data storage media including digital and analog transmission media.

While the foregoing disclosure shows illustrative embodiments of the invention, it should be noted that various changes and modifications could be made herein without departing from the scope of the invention as defined by the appended claims. The activities or steps of the method claims in accordance with the embodiments of the invention described herein need not be performed in any particular order. Furthermore, although elements of the invention may be described or claimed in the singular, the plural is contemplated unless limitation to the singular is explicitly stated.

Preferred embodiments of the present invention have thus been shown and described. It would be apparent to one of ordinary skill in the art, however, that numerous alterations may be made to the embodiments herein disclosed without departing from the spirit or scope of the invention. Therefore, the present invention is not to be limited except in accordance with the following claims.

What is claimed is:

1. A method comprising:
setting a modem card to a particular setting, based on a desired operational mode;
inserting the modem card into a device; and
operating the modem card in accordance with the particular setting.

2. The method of claim 1, wherein setting the modem card comprises:
setting the modem card to a first setting corresponding to an installation mode.

3. The method of claim 2, wherein setting the modem card comprises:
setting a switch on the modem card to a first setting corresponding to the installation Mode.

4. The method of claim 1, wherein setting the modem card comprises:
setting the modem card to a second setting corresponding to a modem functional mode.

5. The method of claim 1, wherein setting the modem card comprises:
setting a switch on the modem card to a second position corresponding to the modem functional mode.

6. The method of claim 2, wherein operating the modem card comprises:
installing at least one program from the modem card.

7. An apparatus comprising:
means for setting a modem card to a particular setting, based on a desired operational mode;
means for inserting the modem card into a device; and
means for operating the modem card in accordance with the particular setting.

8. The apparatus of claim 7, wherein means for setting the modem card further comprises:
setting the modem card to a first setting corresponding to an installation mode.

9. The apparatus of claim 8, wherein means for setting the modem card further comprises:
setting a switch on the modem card to a first position corresponding to the installation mode.

10. The apparatus of claim 7, wherein means for setting the modem card further comprises:
setting the modem card to a second setting corresponding to a modem functional mode.

11. The apparatus of claim 7, wherein means for setting the modem card further comprises:
setting a switch on the modem card to a second position corresponding to the modem functional mode.

12. The apparatus of claim 8, wherein means for operating the modem card further comprises:
installing at least one program from the modem card.

13. A computer-readable medium including computer executable instructions, comprising:
setting a modem card to a particular setting, based on a desired operational mode;
inserting the modem card into a device; and
operating the modem card in accordance with the particular setting.

14. The computer-readable medium of claim 13 including computer executable instructions, wherein setting the modem card comprises:
setting the modem card to a first setting corresponding to an installation mode.

15. The computer-readable medium of claim 14, wherein setting the modem card comprises:
setting a switch on the modem card to a first setting corresponding to the installation mode.

16. The computer-readable medium of claim 13, wherein setting the modem card comprises:
setting the modem card to a second setting corresponding to a modem functional mode.

17. The computer-readable medium of claim 13, wherein setting the modem card comprises:
setting a switch on the modem card to a second position corresponding to the modem functional mode.

18. The computer-readable medium of claim 14, wherein operating the modem card comprises:
installing at least one program from the modem card.
